(19) United States
(12) Patent Application Publication
(10) Pub. No.: US 2004/0253164 A1
(43) Pub. Date: Dec. 16, 2004

(54) Fumed silica produced by flame hydrolysis, process for its production and its use

(75) Inventors: Helmut Mangold, Rodenbach (DE); Matthias Rochnia, Ortenberg (DE)

Correspondence Address: OBLON, SPIVAK, MCCLELLAND, MAIER & NEUSTADT, P.C., 1940 DUKE STREET, ALEXANDRIA, VA, 22314, US

(73) Assignee: DEGUSSA AG, Duesseldorf (DE)

(21) Appl. No.: 10/863,348

(22) Filed: Jun. 9, 2004

(30) Foreign Application Priority Data
Jun. 10, 2003 (DE) 103 26 049.8

(51) Int. Cl. C01B 33/12

(52) U.S. Cl. 423/335

(57) ABSTRACT

A fumed silica powder having a BET specific surface area of between 10 and 600 m²/g, a thickening action of at least 3000 mPas, and a grindometer value of less than 40 μm is produced by mixing i) at least one fumed silica precursor in vapor form, ii) a free-oxygen-containing gas and iii) a combustion gas in a burner with a combustion chamber with attached cooled flame tube to obtain a gas mixture; introducing steam through a tube arranged centrally in the burner into the gas mixture, to obtain a reaction mixture; and reacting the reaction mixture in the combustion chamber; wherein the lambda value is between 1 and 2, the gamma value is between 1 and 2 and the beta value is between 2.2 and 3.2.

### BACKGROUND OF THE INVENTION

1. Field of the Invention

The present invention relates to a fumed silica powder produced by flame hydrolysis, its production and use.

2. Description of the Related Art

The production of fumed silica by flame hydrolysis is known. For example, a mixture of the vapor of a fumed silica precursor, a combustion gas and an oxygen-containing gas, is burned in a cooled combustion chamber. Silicon halides, organochlorosilanes or mixtures of these are generally used for this. In this process, the oxyhydrogen flame of the burner supplies both the energy and also the quantity of water required to hydrolyse the fumed silica precursor. By varying the concentration of the fumed silica precursor, the flame temperature, the combustion gas/air ratio and the residence time in the flame and in the combustion chamber, the particle size, the particle size distribution, the specific surface area and the surface properties of the fumed silica can be widely influenced.

The mixing of the fumed silica precursor, combustion gas, oxygen-containing gas and steam before combustion is known from DE-A-2909815. However, this process is not suitable for large-scale industrial use, as some of the organochlorosilane is prematurely hydrolysed to fumed silica by the steam introduced, and this rapidly blocks up the feed tubes of the combustion chamber. Furthermore, DE-A-2909815 gives no information about the extent to which the added quantity of steam influences the physical-chemical properties of the fumed silica.

It is known from DE-A-2904199, that during flame hydrolysis of silicon halides or organochlorosilanes, in addition to the steam formed by the reaction of a combustion gas with oxygen, steam is additionally fed into the burner or the flame, preferably in a quantity of 0.1 to 1 kg water per kg starting compound. This should be understood to mean that at least the quantity of water required stoichiometrically for complete hydrolysis of the fumed silica precursor is provided by the reaction of oxygen and combustion gas and in addition to this, steam is additionally fed into the system.

According to DE-A-2904199, the steam can be fed in the form of a mixture with a) the combustion gas or b) an oxygen-containing gas. Furthermore, it can be fed in c) before combustion, mixed with the reaction partners or d) introduced directly into the flame. The variants a)-c) have the disadvantage that the fumed silica precursor is hydrolysed prematurely leading to the formation of baked-on deposits of fumed silica. Such a process cannot be carried out economically. The variant d) avoids this disadvantage and makes it possible to produce fumed silica powder with a variable BET specific surface area and thickening action.

The thickening action plays an essential role when using fumed silica powders as a thickening and thixotroping agent. The ability of these powders to be worked into liquid media is also essential for these applications. Although DE-A-2904199 discloses fumed silica powders with a high thickening action, it does not discuss the aspect of ability to be worked in. A high thickening action can only be advantageously used in applications, if the fumed silica powder can easily be worked in.

### SUMMARY OF THE INVENTION

It is an object of the present invention to provide a fumed silica powder which has a high thickening action and good ability to be worked in.

Another object of the present invention is furthermore to provide a process for the production of the fumed silica powder.

This and other objects have been achieved by the present invention the first embodiment of which includes a fumed silica powder having

a BET specific surface area of between 10 and 600 m²/g,

a thickening action of at least 3000 mPas, and

a grindometer value of less than 40 μm.

In another embodiment, the present invention relates to a process for the production of the above fumed silica powder, comprising:

mixing i) at least one fumed silica precursor in vapor form, ii) a free-oxygen-containing gas and iii) a combustion gas in a burner with a combustion chamber with attached cooled flame tube to obtain a gas mixture;

introducing steam through a tube arranged centrally in the burner into the gas mixture, to obtain a reaction mixture; and

reacting the reaction mixture in the combustion chamber;

wherein the lambda value is between 1 and 2, the gamma value is between 1 and 2 and the beta value is between 2.2 and 3.2.

In yet another embodiment, the present invention relates to a dispersion, comprising:

the above fumed silica powder.

In yet another embodiment, the present invention relates to a rubber, silicon rubber or a plastic, comprising:

the above fumed silica powder.

In yet another embodiment, the present invention relates to a paint or a lacquer, comprising:

the above fumed silica powder.

In yet another embodiment, the present invention relates to a catalyst, comprising:

as a support, the above fumed silica powder.

### BRIEF DESCRIPTION OF DRAWINGS

FIG. 1 shows the connection between the gamma value and the added quantity of water.

FIG. 2 shows a diagram of the device and process streams of the process according to the present invention.

FIG. 3-1 shows the thickening action of the fumed silica powders according to the present invention as a function of the beta value.

FIG. 3-2 shows the grindometer values of the fumed silica powders according to the present invention as a function of the beta value.

### DETAILED DESCRIPTION OF THE INVENTION

The present invention provides a fumed silica powder produced by flame hydrolysis with a BET specific surface area of between 10 and 600 m²/g, which has a thickening action of at least 3000 mPas and a grindometer value of less than 40 μm. The BET specific surface area includes all values and subvalues therebetween, especially including 20, 30, 40, 50, 100, 150, 200, 250, 300, 350, 400, 450, 500 and 550 m²/g. The thickening action includes all values and subvalues between 300 mPas and 5000 mPas, especially including 3100, 3200, 3300, 3400, 3500, 3600, 3700, 3800, 3900, 4000, 4100, 4200, 4300, 4400, 4500, 4600, 4700, 4800 and 4900 mPas. The grindometer value includes all values and subvalues between 0 and 40 μm, especially including 5, 10, 15, 20, 25, 30 and 35 μm.

The thickening action (in mPas) is determined in a dispersion of a fumed silica powder in a polyester. The thickening action of the fumed silica powder according to the present invention is at least 3000 mPas. In a preferred embodiment, the thickening action may lie between 3000 and 5000 mPas, values of between 3200 and 4500 being particularly preferred.

The grindometer value is a measure of the fineness of grain of fillers and pigments. It is determined with a grindometer. The material to be tested is placed on the deepest level of a wedge-shaped groove cut into a metal block running towards zero, and drawn along its whole length with a milled scraper. The point at which granular material is revealed as scratches in the smoothed surface is given as the fineness of grind in μm. This is known as the grindometer value. It is a measure of the dispersibility of the powder. The lower the grindometer value, the better the dispersibility. The grindometer value of the fumed silica powder according to the present invention is less than 40 μm. The value may preferably be lower than 35 μm, values lower than 30 μm being particularly preferred.

The BET specific surface area of the fumed silica powder according to the present invention is preferably between 50 and 450 m²/g. BET specific surface areas of between 200 and 400 m²/g are particularly preferred.

In a preferred embodiment, both the thickening action and the grindometer value lie within the given limits. Within these limits, fumed silica powders are obtained that have a high thickening action and at the same time good ability to be worked in (dispersibility).

The present invention further provides a process for the production of the fumed silica powder according to the present invention. In this process, at least one fumed silica precursor in vapor form is burned in the presence of a free-oxygen-containing gas, a combustion gas and steam. The steam is introduced through a tube arranged centrally in the burner into the pre-mixed gas mixture of at least one fumed silica precursor in vapor form, the free-oxgyen-containing gas and the combustion gas. The reaction mixture is reacted in the combustion chamber with attached cooled flame tube. The lambda value is between 1 and 2, the gamma value is between 1 and 2 and the beta value is between 2.2 and 3.2. The lambda value includes all values and subvalues therebetween, especially including 1.1, 1.2, 1.3, 1.4, 1.5, 1.6, 1.7, 1.8 and 1.9. The gamma value includes all values and subvalues therebetween, especially including 1.1, 1.2, 1.3, 1.4, 1.5, 1.6, 1.7, 1.8 and 1.9. The beta value includes all values and subvalues therebetween, especially including 2.3, 2.4, 2.5, 2.6, 2.7, 2.8, 2.9, 3.0 and 3.1.

The lambda and gamma values are defined as follows:

lambda=the oxygen fed into the burner/stoichiometrically required quantity of oxygen;

gamma=the hydrogen fed into the burner/stoichiometrically required quantity of hydrogen.

The values can be varied accordingly when using other gases. A more detailed description of the lambda and gamma values is given in EP-A-855368.

The beta value is defined as follows:

beta=excess water/fumed silica formed.

‘Excess’ means a proportion of water exceeding the proportion required stoichiometrically for hydrolysis of the fumed silica precursor.

The beta value is explained further by the following examples: 5.2 kg/h (0.0306 kmol/h) silicon tetrachloride is burned together with 2.32 m³/h (0.104 kmol/h) hydrogen and 7.3 m³/h (0.068 kmol/h) air, but without additional steam. The quantity of water required stoichiometrically to hydrolyse the silicon tetrachloride is 2×0.0306 kmol/h=0.0612 kmol/h. The reaction of hydrogen and oxygen produces 0.104 kmol/h water. The excess of water is thus (0.104-0.0612) kmol/h=0.0428 kmol/h. The beta value is thus beta=0.0428/0.0306=1.39.

If an additional 500 g/h (0.0278 kmol/h) steam is fed in, this, together with the water from the reaction of hydrogen with oxygen, produces a total of 0.1318 kmol/h water and thus an excess of (0.1318-0.0612) kmol/h=0.0706 kmol/h water. A beta value of 0.0706/0.0306=2.31 can be calculated from this.

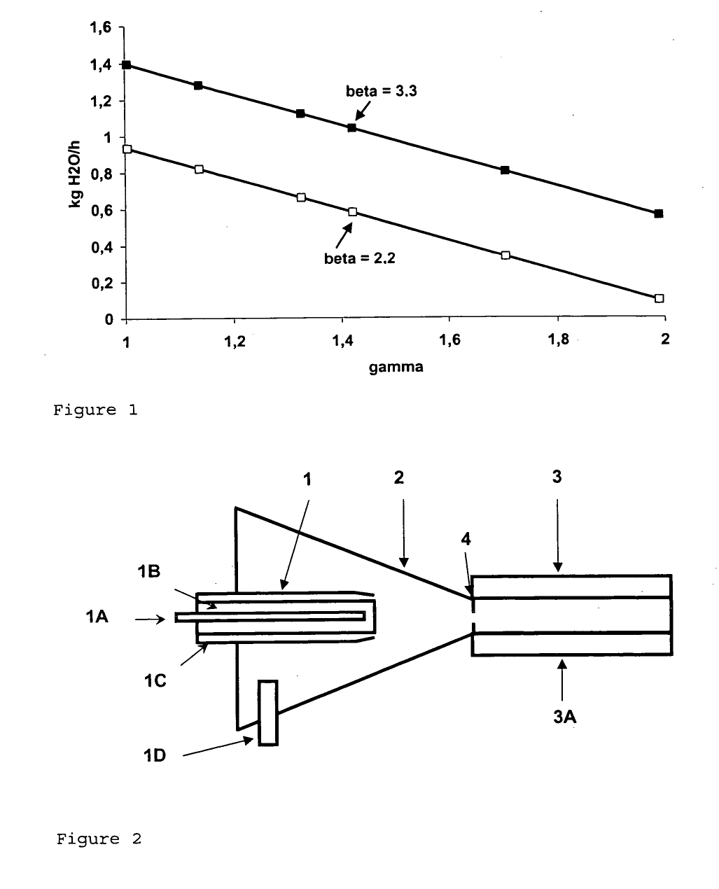

FIG. 1 shows the connection between the gamma value and the added quantity of water on the basis of an example in which 4.00 kg/h silicon tetrachloride is burned in the presence of 2.10 kg/h hydrogen at a lambda value of 1.16. The range between the two straight lines represents the range in which the fumed silica powder according to the present invention is obtained. It can be seen that at high gamma values (maximum 2) little water must be added, at low gamma values (minimum 1) a lot of water must be added, to remain within this range. At settings below the bottom line and above the top line, no fumed silica powders according to the present invention are obtained.

Hydrogen, methane, ethane, propane, butane, natural gas can be used as combustion gases, hydrogen being particularly preferred. Air or oxygen-enriched air is preferably used as the oxygen-containing gas.

Suitable fumed silica precursors may be: silicon halides, organochlorosilicon compounds, organosilicon compounds. SiCl₄, CH₃SiCl₃, (CH₃)₂SiCl₂, (CH₃)₃SiCl, (CH₃)₄Si, HSiCl₃, (CH₃)₂HSiCl, CH₃C₂H₅SiCl₂, disilanes with the general formula RₙCl₃₋ₙSiSiRₘCl₃₋ₘ where R═CH₃ and n+m=2,3,4,5 and 6, and also mixtures of the aforementioned compounds, can be used in particular.

Organochlorosilicon compounds are formed when reacting silicon with organohalides (Müller-Rochow synthesis). The distillation fractions contain various quantities of the above-mentioned organohalogen silicon compounds and organosilicon compounds, which may optionally also contain proportions of C₁-C₁₂-hydrocarbons. The proportion of these hydrocarbons can be up to 10 wt. %, in relation to a fraction. The amount of hydrocarbon includes all values and subvalues between 0 and 10 wt. %, especially including 0.5, 1, 1.5, 2, 2.5, 3, 3.5, 4, 4.5, 5, 5.5, 6, 6.5, 7, 7.5, 8, 8.5, 9 and 9.5 wt. %. These proportions are preferably between 0.01 and 5 wt. %, the proportion of C₆-hydrocarbons, for example cis- and trans-2-hexene, cis- and trans-3-methyl-2-pentene, 2,3-dimethyl-2-butene, 2-methylpentane, 3-methylpentane, generally being predominant.

The distillation fractions of the Müller-Rochow synthesis may be used in the process according to the present invention. Mixtures with a hydrocarbon content of up to 5 wt. % may preferably be used. Mixtures with silicon tetrachloride may particularly preferably be used.

Furthermore, air and/or hydrogen can additionally be fed into the combustion chamber. These measures can be used to vary temperatures and residence times.

FIG. 2 shows a diagram of the device and the process streams of the process according to the present invention. The device for carrying out the process consists of the three main components burner (1), combustion chamber (2) and flame tube (3). The burner comprises a centrally-arranged tube (1A) for the feeding in of steam. Concentrically around the centrally-arranged tube is a jacket pipe (1B) through which the fumed silica precursor, combustion gas and oxygen-containing gas are fed in. A further tube (1C) arranged around the jacket tube (1B) serves for the optional introduction of additional combustion gas. The inlet nozzle (1D) serves for the optional introduction of air. Cooling water is fed in at position (3A). Position 4 is an orifice.

The present invention further provides the use of the fumed silica powder produced by flame hydrolysis according to the present invention for the production of dispersions, as a filler in rubber, silicon rubber and plastics, for adjusting the rheology of paints and lacquers, as a support for catalysts.

Having generally described this invention, a further understanding can be obtained by reference to certain specific examples which are provided herein for purposes of illustration only, and are not intended to be limiting unless otherwise specified.

### EXAMPLES

The thickening action was determined by the following method: 7.5 g fumed silica powder were introduced into 142.5 g of a solution of an unsaturated polyester resin in styrene with a viscosity of 1300+/−100 mPas at a temperature of 22° C. and were dispersed with a dissolver at 3000 rpm. Ludopal® P6, BASF, for example, was suitable as the unsaturated polyester resin. 60 g of this dispersion were added with a further 90 g of the unsaturated polyester resin to styrene and the dispersing process was repeated. The viscosity value in mPas of the dispersion at 25° C., measured with a rotational viscometer at a shear rate of 2.7 rps, was described as the thickening action.

The BET specific surface area was determined according to DIN 66131 which is equivalent to ISO 9277.

### Example A1

The mixture of 4.00 kg/h SiCl₄ in vapor form, 2.10 m³/h hydrogen and 7.00 m³/h air was ignited and burned from the outlet opening of the burner into the combustion chamber and further into the cooled flame tube. The fumed silica powder formed was separated from the gases and de-acidified. The physical-chemical data of the fumed silica powder are given in Table 1.

Examples A2-A8 and B1-B7 were carried out as example A1, however water was fed in. The water was added through a centrally arranged tube, which was enclosed by the feed for the reaction partners silicon tetrachloride, hydrogen and air. The required quantities and the physical-chemical data of the fumed silica powder obtained are given in Table 1.

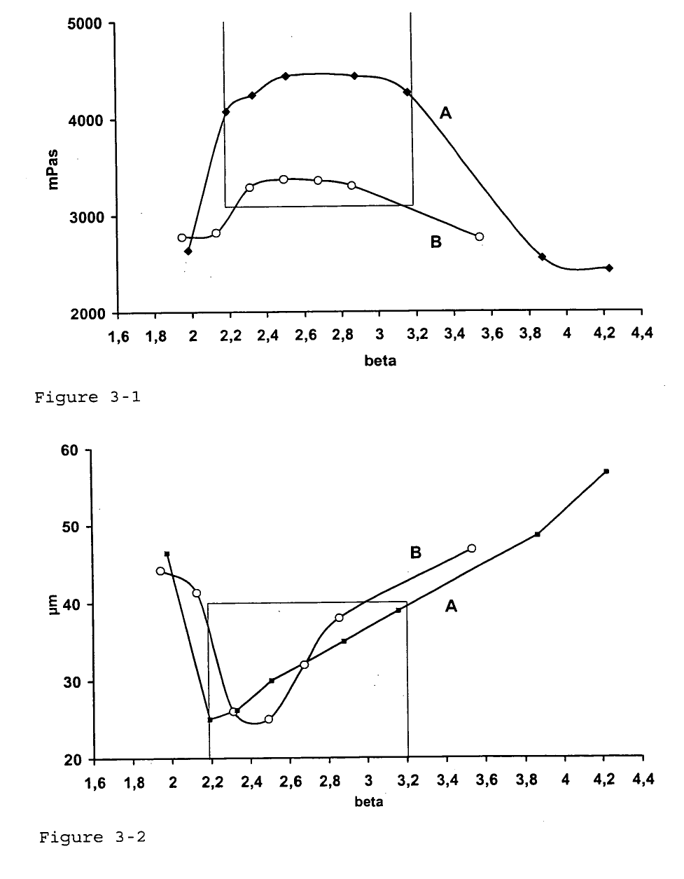

FIG. 3-1 shows the thickening action (in mPas) of the fumed silica powder from all Examples A (A1-A8) and all Examples B (B1-B7) as a function of the beta value at a constant gamma value of 1.99 in series A and of 1.43 in series B.

FIG. 3-2 shows the corresponding grindometer values (in μm) as a function of the beta value.

The box in FIG. 3-1 between beta values 2.2 and 3.2 and the thickening action of 3000 mPas, shows the range according to the present invention. Accordingly, for FIG. 3-2, the box shows the range according to the present invention between the beta values 2.2 and 3.2 and the grindometer value of less than 40 μm.

In Examples C1 and C2, mixtures were used as fumed silica precursors. In C1 a mixture of SiCl₄ (90 wt. %), MeSiCl₃ (9.8 wt. %) and hydrocarbons (ca 0.2 wt. %) was used, in C2 a mixture of MeSiCl₃ (85 wt. %), Me₂SiCl₂ (4.7 wt. %), MeSiHCl₂(5.3 wt. %) and hydrocarbons (ca. 5 wt. %) was used. A fumed silica powder according to the present invention was obtained also with these precursor mixtures.

TABLE 1
Required quantities and properties of fumed silica powders

| | H₂O | | | | | | | | | Grindo-meter |
|---|---|---|---|---|---|---|---|---|---|---|
| | added | SiCl₄ | Hydrogen | Air | | | | BET | Thickening | value |
| Example | g/h | kg/h | m³/h | m³/h | Gamma | Lambda | Beta | m²/g | mPas | μm |
| A1* | 0 | 4.00 | 2.10 | 7.00 | 1.99 | 1.79 | 1.98 | 218 | 2640 | 46.4 |
| A2 | 90 | 4.00 | 2.10 | 6.85 | 1.99 | 1.73 | 2.19 | 255 | 4075 | 25.0 |
| A3 | 150 | 4.00 | 2.10 | 6.75 | 1.99 | 1.69 | 2.33 | 281 | 4240 | 26.2 |
| A4 | 223 | 4.00 | 2.10 | 6.65 | 1.99 | 1.65 | 2.51 | 317 | 4435 | 30.0 |
| A5 | 380 | 4.00 | 2.10 | 6.30 | 1.99 | 1.51 | 2.88 | 385 | 4430 | 35.0 |
| A6 | 500 | 4.00 | 2.10 | 6.15 | 1.99 | 1.45 | 3.16 | 386 | 4260 | 38.9 |
| A7* | 800 | 4.00 | 2.10 | 5.70 | 1.99 | 1.28 | 3.87 | 418 | 2550 | 48.5 |
| A8* | 955 | 4.00 | 2.10 | 5.30 | 1.99 | 1.11 | 4.23 | 411 | 2430 | 56.7 |
| B1* | 600 | 5.18 | 1.95 | 5.40 | 1.43 | 1.16 | 1.95 | 308 | 2780 | 44.2 |
| B2* | 700 | 5.18 | 1.95 | 5.40 | 1.43 | 1.16 | 2.13 | 322 | 2823 | 41.3 |
| B3 | 800 | 5.18 | 1.95 | 5.40 | 1.43 | 1.16 | 2.31 | 336 | 3289 | 26.0 |
| B4 | 900 | 5.18 | 1.95 | 5.40 | 1.43 | 1.16 | 2.49 | 351 | 3370 | 25.0 |
| B5 | 1000 | 5.18 | 1.95 | 5.40 | 1.43 | 1.16 | 2.68 | 364 | 3355 | 32.0 |
| B6 | 1100 | 5.18 | 1.95 | 5.40 | 1.43 | 1.16 | 2.86 | 376 | 3300 | 38.0 |
| B7* | 1200 | 5.18 | 1.95 | 5.40 | 1.43 | 1.16 | 3.54 | 378 | 2760 | 46.7 |
| C1 | 250 | 4.00^{a)} | 1.95 | 6.70 | 1.97 | 1.26 | 2.48 | 310 | 3300 | 32.0 |
| C2 | 800 | 5.18^{b)} | 0.55 | 12.50 | 1.96 | 1.05 | 2.70 | 282 | 3050 | 37.0 |

*(Reference example;
^{a)}Mixture consisting of: SiCl₄ (90 wt. %), MeSiCl₃ (9.8 wt.-%) and hydrocarbons (ca. 0.2 wt. %);
^{b)}Mixture consisting of: MeSiCl₃ (85 wt. %), Me₂SiCl₂ (4.7 wt. %), MeSiHCl₂ (5.3 wt. %) and hydrocarbons (ca. 5 wt. %).

German patent application 103 26 049.8 filed Jun. 10, 2003, is incorporated herein by reference.

Numerous modifications and variations on the present invention are possible in light of the above teachings. It is therefore to be understood that within the scope of the appended claims, the invention may be practiced otherwise than as specifically described herein.

1. A fumed silica powder having
a BET specific surface area of between 10 and 600 m²/g,
a thickening action of at least 3000 mPas, and
a grindometer value of less than 40 μm.

2. The fumed silica powder according to claim 1, wherein the BET specific surface area is between 50 and 450 m²/g.

3. The fumed silica powder according to claim 1, produced by flame hydrolysis.

4. A process for the production of the fumed silica powder according to claim 1, comprising:
mixing i) at least one fumed silica precursor in vapor form, ii) a free-oxygen-containing gas and iii) a combustion gas in a burner with a combustion chamber with attached cooled flame tube to obtain a gas mixture;
introducing steam through a tube arranged centrally in the burner into the gas mixture, to obtain a reaction mixture; and
reacting the reaction mixture in the combustion chamber;
wherein the lambda value is between 1 and 2, the gamma value is between 1 and 2 and the beta value is between 2.2 and 3.2.

5. The process according to claim 4, wherein the fumed silica precursor is at least one member selected from the group consisting of a silicon halide, an organochlorosilicon compound, an organosilane and mixtures thereof.

6. The process according to claim 4, wherein the fumed silica precursor is silicon tetra chloride.

7. The process according to claim 4, wherein the BET specific surface area of the fumed silica powder is between 50 and 450 m²/g.

8. The process according to claim 4, wherein the combustion gas is selected from the group consisting of hydrogen, methane, ethane, propane, butane, and natural gas.

9. The process according to claim 4, wherein the combustion gas is hydrogen.

10. The process according to claim 4, wherein the free-oxygen-containing gas is selected from the group consisting of air and oxygen-enriched air.

11. The process according to claim 4, wherein the fumed silica precursor is selected from the group consisting of SiCl₄, CH₃SiCl₃, (CH₃)₂SiCl₂, (CH₃)₃SiCl, (CH₃)₄Si, HSiCl₃, (CH₃)₂HSiCl, CH₃C₂H₅SiCl₂, disilanes of the formula RnCl₃₋ₙSiSiRₘCl₃₋ₘ wherein R═CH₃ and n+m=2,3,4,5 and 6, and mixtures thereof.

12. The process according to claim 5, wherein the organochlorosilicon is mixed with up to 10 wt. % C₁-C₁₂-hydrocarbons, based on the total weight of the mixture.

13. The process according to claim 12, wherein the hydrocarbon comprises mainly C₆-hydrocarbons.

14. The process according to claim 5, wherein the organochlorosilicon is mixed with silicon tetrachloride.

15. The process according to claim 4, wherein air and/or hydrogen are additionally fed into the combustion chamber.

16. A dispersion, comprising:
the fumed silica powder according to claim 1.

17. A rubber, silicon rubber or a plastic, comprising:
the filmed silica powder according to claim 1.

18. A paint or a lacquer, comprising:
the fumed silica powder according to claim 1.

19. A catalyst, comprising:
as a support, the filmed silica powder according to claim 1.
